(19) United States
(12) Patent Application Publication
(10) Pub. No.: US 2025/0094591 A1
(43) Pub. Date: Mar. 20, 2025

(54) DISTRIBUTION OF BLUEPRINTS IN EDGE SYSTEMS

(71) Applicant: Dell Products L.P., Round Rock, TX (US)

(72) Inventors: MAXIM BALIN, Gan-Yavne (IL); ELIYAHU ROSENES, Bet Shemesh (IL)

(21) Appl. No.: 18/468,285

(22) Filed: Sep. 15, 2023

(51) Int. Cl. G06F 21/57; G06F 11/34; G06F 21/60; G06F 21/64

(52) U.S. Cl. CPC G06F 21/57; G06F 11/3476; G06F 21/602; G06F 21/64

(57) ABSTRACT

Methods and systems for managing operation of edge devices are disclosed. The operation of the edge devices may be managed using blueprints. A blueprint may indicate a workflow for modifying operation of an edge device, and components to be used in the workflow. A security framework may be used to secure the distribution and use of the blueprints by edge systems. The security framework may include various checks to confirm that a blueprint is trustworthy and approved for use with edge systems. The checks may be performed prior to use of the blueprints.

### FIELD

Embodiments disclosed herein relate generally to workload management. More particularly, embodiments disclosed herein relate to systems and methods to manage workload distribution across shared infrastructure.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing services using edge devices. To provide services using edge devices, the edge devices may host various pieces of software, may be configured in certain manners, and/or may be adapted to provide the computer implemented services in various ways.

To modify the computer implemented services provided by the edge devices, the software, configurations, and/or other aspects of the edge devices may need to be modified. To modify the edge devices to provide the computer implemented services, blueprints which document modification workflows and components for the edge devices may be established. The blueprints may be deployed to the edge devices, and automation software may use the blueprints to conform the operation of the end devices to that specified by the blueprints.

To reduce avenues for compromise of the edge devices and/or other devices, a security framework may be used. The security framework may govern how blueprints are generated and used in a system. The security framework may specify certain checks that are performed prior to use of a blueprint. The checks may include cryptographic verified to establish trust in data structures to manage modifications to the operation of edge devices.

Thus, embodiments disclosed herein may address, among others, the technical problem of security in a distributed system. By implementing the security framework, the distributed system may be less susceptible to compromise through use of data structure distributed between members of the distributed system. Trust in the data structures may be established through cryptographic checks, thereby providing assurances to entities of the systems regarding authenticity of data transmitted through the distributed system.

In an embodiment, a method for managing operation of endpoint devices of a deployment is provided. The method may include obtaining, by an endpoint device of the endpoint devices, a blueprint token that indicates that the endpoint device is to implement a blueprint; in response to obtaining the blueprint token and by the endpoint device: making a first determination regarding whether a blueprint specified by the blueprint token is trusted; in a first instance of the first determination where the blueprint is trusted: making a second determination regarding whether the blueprint is authorized for use by the endpoint device; in a first instance of the second determination where the blueprint is authorized for use by the endpoint device: making a third determination regarding whether integrity of the blueprint can be verified; in a first instance of the third determination where the integrity of the blueprint can be verified: implementing a portion of objects specified by the blueprint that can be verified, the objects being implemented in an order specified by the blueprint, and implementation of the portion of the objects conforming the operation of the endpoint device to the blueprint; and providing computer implemented services using at least the portion of objects.

The method may also include in the first instance of the third determination where the integrity of the blueprint can be verified: while the objects are being implemented, logging activity of the endpoint device to obtain an auditable implementation trail for the endpoint device.

Making the first determination may include obtaining verification data for the blueprint; and attempting to verify trust in the blueprint using the verification data to make the first determination.

The verification data may include a hash of the blueprint that is signed, and attempting to verify the trust in the blueprint comprises using a public key to check a signature applied to the hash.

Making the second determination may include obtaining at least one assignment for blueprints to the endpoint device; and comparing the blueprint to the blueprints to ascertain whether the blueprint is one of the blueprints to make the second determination.

Each of the at least one assignment may attest an assignment of at least one of the blueprints for use by the endpoint device, the at least one assignment being made by an administrator, and the at least one assignment being cryptographically verifiable by the endpoint device.

Making the third determination may include obtaining verification data for the blueprint; and comparing a first hash in the verification data to a second hash of the blueprint to make the third determination.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may initiate performance the computer-implemented method when the computer instructions are executed by the processor.

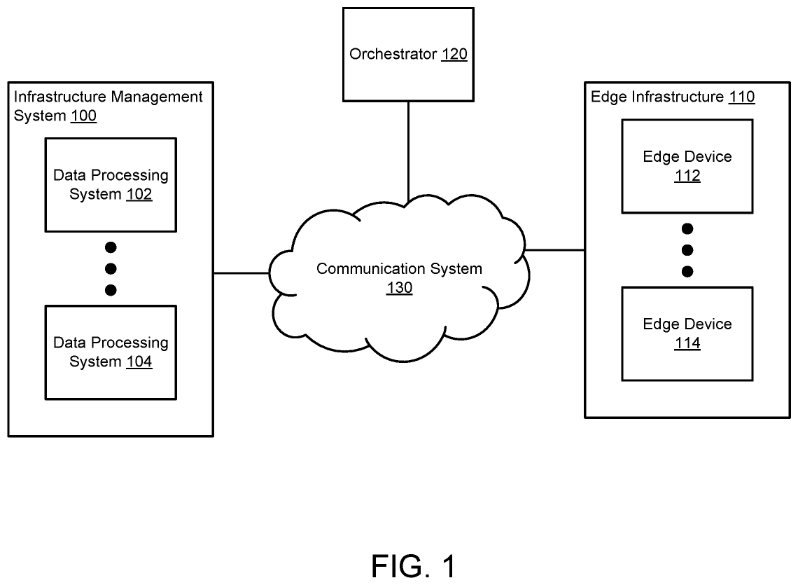

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, transaction processing services, and/or any other type of service that may be implemented with a computing device.

To provide the computer implemented services, the system may include edge infrastructure 110. Edge infrastructure 110 may include any number of edge devices (e.g., 112, 114). The edge devices may cooperatively and/or individually provide all, or a portion of the computer implemented services.

To contribute to the computer implemented services, the edge devices may host certain software, may be configured in certain manners, and/or may otherwise be modified to meet one or more requirements to contribute to the computer implemented services. Further, groups of edge devices may be modified to cooperatively provide various services. For example, some edge devices of a group may host some software to provide some functions while other edge devices of a group may host different software to provide other functions which, in aggregate, allow desired computer implemented services to be provided.

However, due to the placement of edge devices (e.g., at an edge installation) and the resources of the edge devices, the edge devices may be more susceptible to malicious activity. For example, any of the edge devices may be part of an edge installation which may subject the edge devices to physical attacks (e.g., malicious devices may be operably connected to the edge devices by attaching the malicious device to a port of a network interconnecting the edge devices), network attacks (e.g., networks that support operation of the edge installation may include fewer security mechanisms than would be present in other computing environments such as data centers), and/or the edge device may be subject to more vectors of attack for other reason when compared to computing devices located in other computing environments.

Further, by virtue of the expanded number of attack vectors, the need to modify (e.g., install software, change configuration settings) the edge devices to provide the desired computer implemented services in combination with may subject the edge devices to higher risk of compromise. For example, to modify the operation of the edge devices, information regarding the modifications may be transmitted to the edge devices because the edge devices may be remote to other computing resources, administrators tasked with managing the edge devices, etc. A malicious device may attempt to utilize these communications of modifications as an additional vector of attack. The malicious device may attempt to impersonate a management device that manages the edge devices with respect to modification, another edge device, etc.

In general, embodiments disclosed herein may provide methods, systems, and/or devices for managing the operation of edge infrastructure. To manage the edge infrastructure, a security framework for modifying the edge infrastructure to provide various computer implemented services may be enforced. The security framework may include multiple layers of verification and/or validation during modification of edge devices. The verification and/or validation may reduce the likelihood of edge devices (and/or management systems) being compromised.

By doing so, embodiments disclosed herein may provide a system that is more likely to provide desired computer implemented services by reducing the likelihood of members of the system being compromised.

To provide the above noted functionality, the system of FIG. 1 may include infrastructure management system 100, edge infrastructure 110, orchestrator 120, and communication system 130. Each of these components is discussed below.

Infrastructure management system 100 may facilitate modification of edge infrastructure 110. Infrastructure management system 100 may include any number of data processing systems (e.g., 102, 104). The data processing systems may be used by administrators, architects, and/or other persons that manage edge infrastructure 110 to provide desired computer implemented services.

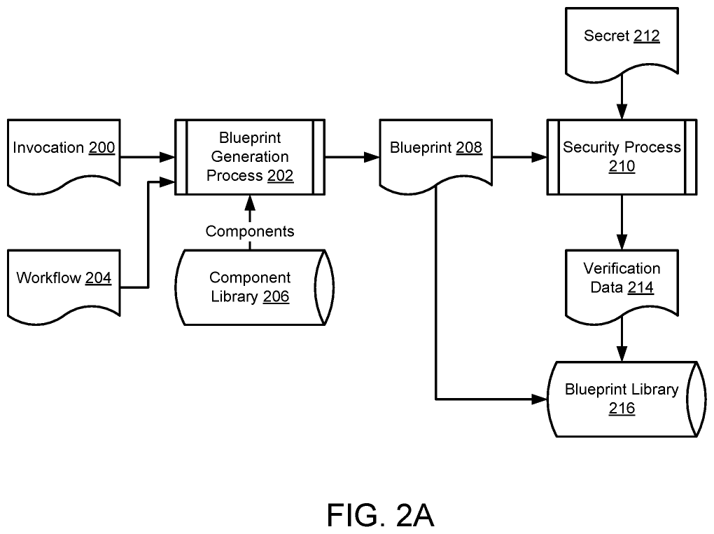

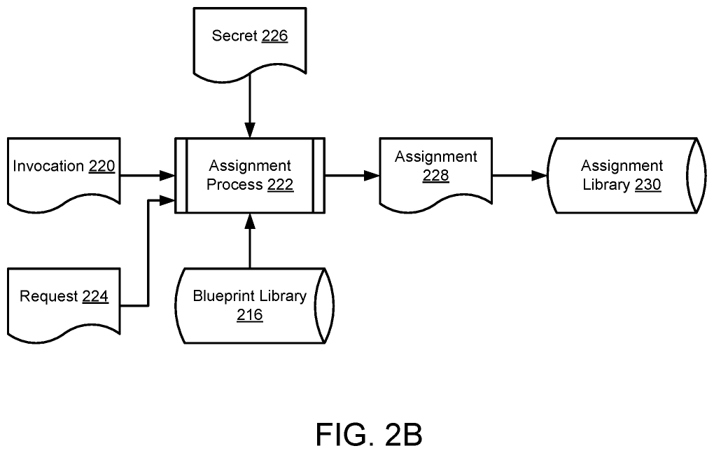

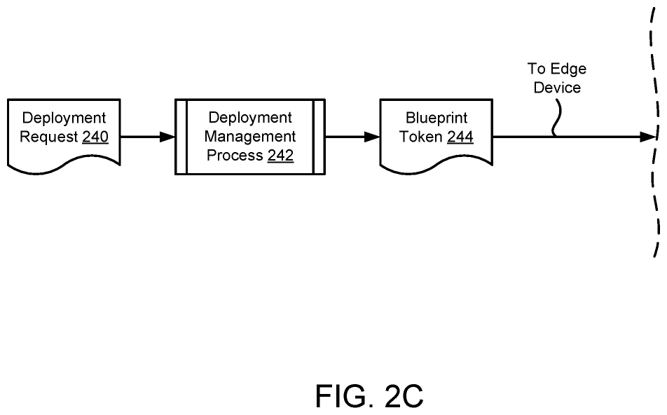

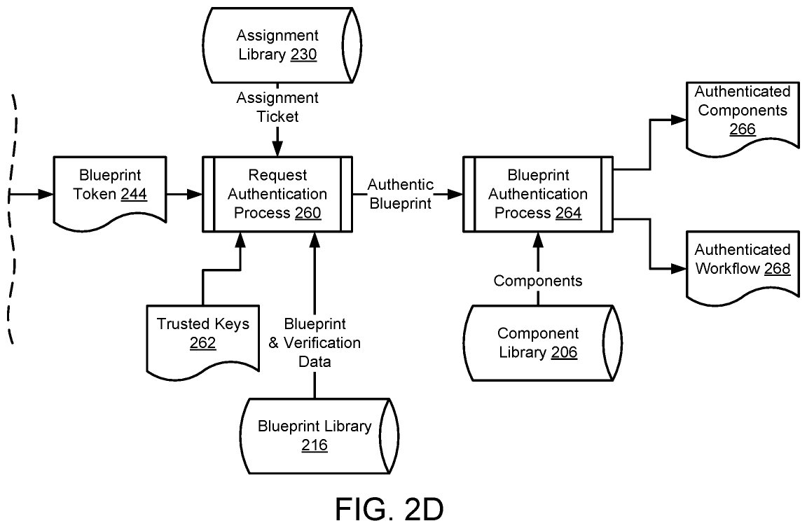

The architects may be system administrators tasked with establishing modifications to edge infrastructure 110 that result in desired computer implemented services being provided. The modifications may be captured as blueprints. The blueprints may be data structures that specify components (e.g., software, configuration settings, etc.) and workflows for implementing the components on edge devices. The data processing systems may host software tools (e.g., development environments) for defining the blueprints. Additionally, the software may facilitate generation of verification data for blueprints usable to (i) establish trust in the blueprints, and (ii) verify integrity of the blueprints. Refer to FIGS. 2A for additional details regarding blueprints and verification data.

The administrators may also be system administrators, but that are tasked with establishing (i) where blueprints may be used, and (ii) when to use blueprints. To establish where blueprints may be used, the administrators may use a portal or other interface provided by orchestrator 120. The portal may be used by the administrators to define with which of the edge devices (e.g., 112-114) each blueprint may be used. Such definitions may be established by sufficiently privileged administrators (e.g., not all administrators may be so privileged). Refer to FIG. 2B for additional details regarding defining where each blueprint may be used.

To establish when a blueprint is to be used, the administrators may also use a portal or other interface provided by orchestrator 120. The portal may be used by the administrators to initiate modification of an edge device based on a blueprint. When doing so, a cryptographically verifiable token that is also replay attack resistant may be generated. Orchestrator 120 may provide the token to a corresponding edge device to initiate modification of the edge device by automation software hosted by the edge device and/or orchestrator 120. Refer to FIG. 2C for additional details regarding initiation of modification of edge devices.

Orchestrator 120 may manage edge infrastructure 110. To manage edge infrastructure 110, orchestrator 120 may present interfaces to users of data processing systems 102-104 of infrastructure management system 100. The interfaces may allow privileged users (e.g., administrators, architects, etc.) to (i) define limits on use of blueprints with respect to various edge devices, and (ii) initiate modification of edge devices of edge infrastructure 110 using various blueprints. Refer to FIGS. 2B-2D for additional details regarding management of edge infrastructure by orchestrator 120.

Edge infrastructure 110, as noted above, may provide computer implemented services. To provide the computer implemented services, the edge devices of edge infrastructure 110 may (i) implement a security framework usable to vet modifications to their operation prior to enabling the modifications to be made, and (ii) host automation software through which blueprints may be used to modify themselves through, for example, deployment of new software, removal/modification of existing software, modification of various configurations, etc. Refer to FIG. 2D for additional details regarding the security framework used to analyze modifications prior to implementation of the modifications.

The automation software may, as part of implementing a modification, may also verify components specified by the blueprints prior to utilizing the components. For example, a blueprint may specify that a particular piece of software is to be installed as part of a modification workflow. Prior to installing the software, the automation software may verify that an image of the software is trustworthy (e.g., by checking a hash of the software image against a trusted hash registry). If any of the components are deemed to not be trustworthy, then various remedial actions may be performed. The remedial actions may include, for example, (i) attempting to identify other images for the component that may be trustworthy, (ii) attempting to identify other trusted hashes that may be used to vet the component, (iii) notifying and/or otherwise involving an administrator (e.g., the administrator may approve or reject installation of a component that cannot be cryptographically verified as being trustworthy), (iv) the component may be rejected, (v) a fork in a workflow may be taken (e.g., modification workflows may include contingencies in case various components cannot be verified), and/or (vi) other actions usable to address components that cannot be initially verified as being trustworthy may be performed to place the edge device in a desired operable condition (e.g., based on a blueprint that defines the modification workflow).

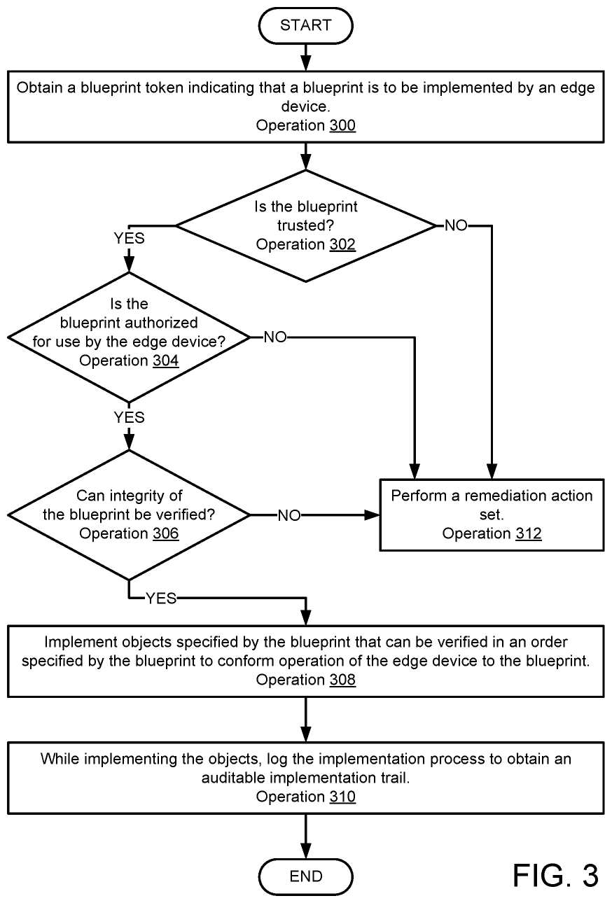

When providing their functionality, any of (and/or components thereof) infrastructure management system 100, edge infrastructure 110, and/or orchestrator 120 may perform all, or a portion, of the actions methods illustrated in FIGS. 2A-3.

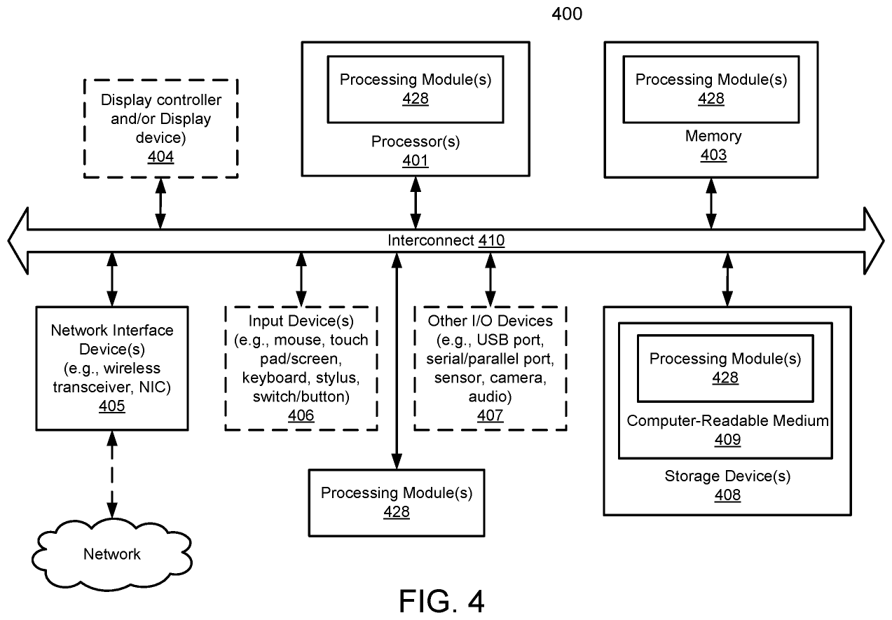

Any of (and/or components thereof) infrastructure management system 100, edge infrastructure 110, and orchestrator 120 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 204, etc.) is used to represent data structures, a second set of shapes (e.g., 202, 210, etc.) is used to represent processes performed using and/or that generate data, and a third set of shapes (e.g., 206, 216, etc.) is used to represent large scale data structures such as databases.

Turning to FIG. 2A, a first data flow diagram in accordance with an embodiment is shown. The first data flow diagram may illustrate data used in and data processing performed in establishment of blueprints usable to modify edge devices.

To establish blueprints, an administrator or other person may utilize a development environment. The development environment may enable blueprints to be defined and verification data to be established.

To define a blueprint, the person using the development environment may supply user input defining invocation 200. Invocation 200 may invoke functionality of the development environment through which a blueprint may be defined. Invocation 200 may be ingested by blueprint generation process 202. During blueprint generation process 202, the user input of invocation 200 may be used to (i) identify components for the blueprint (e.g., the person may select the components), and (ii) define a modification workflow (e.g., 204) for the blueprint.

For example, a component library (e.g., 206) of trusted components may be used to provide the user with information regarding components available for use in blueprints. The content of the component library may be vetted for security, trust, and/or other characteristics by a subject matter expert, an automated process, etc. The person may be provided with information regarding these components, and may be allowed to select any of the components for integration into the blueprint.

Workflow 204 may specify actions to be performed, an ordering of the actions, forks (e.g., actions that are dependent on the outcomes of other actions), and/or other aspects of activity to be performed by an edge device during a modification. For example, workflow 204 may specify (i) when each component is to be installed during a modification, (ii) when changes to configurations are to be made, (iii) logging activity (e.g., the type of information regarding the modification that is to be document) to perform during the modification, and/or other information regarding how a modification is to be performed.

The components (e.g., identifiers for them, trusted sources of the components such as image libraries) and workflow 204 may be used to obtain blueprint 208. Blueprint 208 may specify the modification workflow and components used in the modification workflow.

Once obtained, blueprint 208 may be ingested by security process 210. During security process 210, verification data 214 may be generated. Verification data 214 may be usable to (i) establish trust in a blueprint, and (ii) verify integrity of the blueprint. To do so, verification data 214 may include a security data (e.g., a hash) for blueprint 208 and a signature.

The signature may be generated using secret 212. Secret 212 may be a private key of a public-private keypair. The private key may be kept secret, while the public key may be published for use by the edge devices of edge infrastructure. The public key may be usable to cryptographically verify the signature.

Once verification data 214 is obtained, blueprint 208 and verification data 214 may be stored in blueprint library 216. Information from blueprint library 216 may be distributed to edge devices so that the edge devices may trust the blueprints and verify integrity of the blueprints.

Turning to FIG. 2B, a second data flow diagram in accordance with an embodiment is shown. The second data flow diagram may illustrate data used in and data processing performed in establishment of limitations on use of blueprints.

To establish limitations on use of blueprints, a privileged administrator or other person may utilize a portal or other interface provided by an orchestrator. The portal may enable assignments (e.g., 228) for blueprints to be defined.

To define an assignment, the person using the portal may supply user input defining invocation 220. Invocation 220 may invoke functionality of the orchestrator through which an assignment may be defined. Invocation 220 may be ingested by assignment process 222. During assignment process 222, the user input of invocation 220 may be used to (i) identify edge devices with which a blueprint may be used, and (ii) generate a cryptographically verifiable assignment (e.g., 228).

To identify the edge devices with which a blueprint may be used, information regarding available blueprints from blueprint library 216 may be presented to the user. The user may select one or more of the blueprints. Additionally, the user may select any number of edge devices with which the blueprints may be used from the edge devices managed by the orchestrator (and/or other orchestrators).

The identifiers of the blueprints and selected edge devices may be added to a data structure. The data structure may then be signed using secret 226 to obtain assignment 228. Secret 226 may be a private key of a public-private keypair. The private key may be kept secret, while the public key may be published for use by the edge devices of edge infrastructure. The public key may be usable to cryptographically verify the signature of assignment 228. Thus, if the edge devices trust the keypair, verification of the signature using the public key may establish trust in assignment 228.

Once obtained, assignment 228 may be stored in assignment library 230. Various assignments from assignment library 230 may be distributed to the edge devices.

Turning to FIG. 2C, a third data flow diagram in accordance with an embodiment is shown. The third data flow diagram may illustrate data used in and data processing performed in modification of edge devices.

To initiate modification of an edge device, a privileged administrator or other person may utilize a portal or other interface provided by an orchestrator. The portal may be used to initiate modification of edge devices using blueprints.

To initiate modification of an edge device, the person using the portal may supply user input defining deployment request 240. Deployment request 240 may invoke functionality of the orchestrator through which a modification of an edge device may be initiated. Deployment request 240 may be ingested by deployment management process 242. During deployment management process 242, the user input of deployment request 240 may be used to (i) verify that the person has sufficient privilege to initiate the modification, (ii) identify the blueprint for use in the modification, and/or (iii) generate a cryptographically verifiable blueprint token (e.g., 244).

For example, the user input may include credentials (e.g., username/password/etc.) for the person. The credentials may be used to identify the privilege of the person with respect to initiating modification of edge device.

If sufficiently privileged, identifiers for the edge device and the blueprint provided by the user (e.g., the user may select the edge device and the blueprint from menus presented to the user) may be used to identify the edge device that is to be modified and the blueprint to be used to perform the modification. Once identified, blueprint token 244 may be generated.

Blueprint token 244 may include payload that includes (i) an identifier of the token, (ii) a timestamp and/or other information to resist replay attacks, (iii) identification information for the edge device that is to be modified, and/or (iv) other information usable to secure the modification, facilitate performance of the modification, and/or otherwise complete the modification of the edge device. The payload may be signed with a secret (e.g., private key of a keypair) so that the edge devices may trust the blueprint token.

Once generated, blueprint token 244 may be distributed to the edge device directly and/or indirectly.

Turning to FIG. 2D, a fourth data flow diagram in accordance with an embodiment is shown. The fourth data flow diagram may illustrate data used in and data processing performed in modification of an edge device using a blueprint.

When an edge device obtains blueprint token 244, the edge device may (i) vet a modification workflow indicated by blueprint token 244 using the security framework discussed with respect to FIG. 1, and (ii) implement the modification workflow if successfully vetted.

To verify the modification workflow, request authentication process 260 may be performed. During request authentication process 260, the authenticity of the request for performance of the modification workflow and acceptability of the request may be verified. If the request (e.g., as specified by blueprint token 244) can be verified and is acceptable, then a blueprint may be verified (e.g., to obtain an authentic blueprint). If successfully verified, then an authenticated blueprint may be identified and selected for additional analysis and/or use.

To verify the request, trusted keys 262 may be used to attempt to verify a signature from blueprint token 244. Trusted keys 262 may be public keys that are trusted by an edge device (and/or orchestrator).

If the signature is verified, then the content of blueprint token 244 may be used to verify that a replay attack is unlikely to be being made using the request. For example, the content of blueprint token 244 may be verified using the signature, and a timestamp or other data may be checked to ensure that blueprint token 244 is not being used again. For example, the timestamp may be compared to the current time to ascertain whether blueprint token 244 was generated sufficient long ago that it should not be used. In another example, a unique identifier for blueprint token 244 may be compared against a list of unique identifiers of previously used blueprint tokens to ascertain whether the blueprint token has been previously used.

If it is determined that a replay attack is not being performed using blueprint token 244, then blueprint token 244 may be treated as being verified.

To verify that the requested modification specified by blueprint token 244 is also acceptable, the blueprint specified by blueprint token 244 may be checked against assignment tickets from assignment library 230 to verify that the blueprint is authorized for use with an edge device specified by blueprint token 244. The signatures of the assignment tickets may also be checked with trusted keys 262 to verify that they are trusted, and the content of trusted assignment tickets may be checked to determine which blueprints are authorized for use with the edge device that is to perform the modification workflow specified by blueprint token 244.

If verified as being usable with the edge device, then a copy of the blueprint and verification data for the blueprint may be obtained (e.g., from blueprint library 216). The signature of the verification data may be checked using trusted keys 262, and if verified as trustworthy then the content of the verification data may be used to verify the integrity of the blueprint. For example, a hash of the blueprint may be generated and compared to hashes in the content of the verification data. It will be appreciated that other types of data may be used to verify the integrity of the blueprint without departing from embodiments disclosed herein. If the generated hash matches a hash in the verification data, then the integrity of the blueprint may be treated as being verified.

If the blueprint is verified bas being available for use with the edge device and the integrity of the blueprint is verified, then the requested modification workflow specified by blueprint token 244 may be treated as being acceptable.

If the modification workload is verifiable and acceptable, then the blueprint specified by blueprint token 244 may be treated as being acceptable for use and provided to blueprint authentication process 264.

Prior to (and/or at the same time as) performing the modification workflow specified by an authentic blueprint, blueprint authentication process 264 may be performed to verify that the components specified by the blueprint are trusted. During blueprint authentication process 264, each component specified by the authentic blueprint verified as being trustworthy. The determination for each component may be performed by comparing hashes of the components to a trusted hash repository (not shown) or other data structure in which verification data for trusted components is stored. Components specified by the authentic blueprint that cannot be verified (e.g., by hash matching) may be omitted from use in the modification workflow.

For example, only authenticated components 266 that have been verified as being trusted may be authorized for use during the modification workflow. Corresponding portions of the modification workflow may be removed (or otherwise omitted from performance) to obtain an authenticated workflow 268.

Once authenticated workflow 268 and authenticated components 266 are obtained, then automation software or other types of management entities may perform authenticated workflow 268 using authenticated components 266.

For example, authenticated workflow 268 may specify a set of actions to be performed in a particular sequence. The automation software may initiate performance of the actions in the specified order. The actions may cause authenticated components 266 to be used during the modification workflow. For example, various pieces of software may be installed, new settings may be created, new data structure may be created, and/or other entities may be instantiated based on authenticated components 266.

As part of the performance of authenticated workflow 268, various actions may be performed to create an auditable log. The auditable log may specify, for example, (i) the actions performed during performance of authenticated workflow 268, (ii) entities created during the performance, (iii) forks in authenticated workflow 268 taken during the performance, (iv) telemetry information (e.g., temperatures of hardware components, power consumption levels, activity messages generated by the components, etc.), (v) information regarding errors or other unexpected activity during the performance, and/or other information usable to diagnose root causes of deviations of the performance from expected performances of authenticated workflow 268 and/or expected outcomes and/or perform other types of analysis of the performance.

It will be appreciated that while described as being performed prior to use of authenticated components 266 and authenticated workflow 268 by automation software, it will be appreciated that blueprint authentication process 264 may be performed while the modification workflow is being performed. Thus, portions of the modification workflow may be performed while authenticated components 266 are identified and various actions for authenticated workflow 268 are identified.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2D, the computer implemented services provided by edge devices may be modified over time in a manner that less likely to result in compromises of the edge devices and/or other devices (e.g., orchestrators, other edge devices) that interact with the edge devices through use of a security framework.

As discussed above, the components of FIG. 1 may perform various methods to manage operation of edge devices. FIG. 3 illustrates a method that may be performed by the components of the system of FIG. 1. In the diagram discussed below and shown in FIG. 4, any of the operations may be repeated, performed in different orders, and/or performed in parallel with or in a partially overlapping in time manner with other operations.

Turning to FIG. 3, a flow diagram illustrating a method for managing modification of operation of an edge device to provide desired computer implemented services in accordance with an embodiment is shown. The method may be performed by any of (and/or components thereof) infrastructure management system 100, edge infrastructure 110, orchestrator 120, and/or other components of the system shown in FIG. 1.

Prior to operation 300, privileged user (e.g., an administrator) may select a blueprint for implementation by an edge device. A blueprint token may be generated and forwarded to an edge device and/or orchestrator that manages the edge device. The blueprint token may indicate a blueprint for implementation by the edge device.

At operation 300, the blueprint token is obtained by the edge device. The blueprint token may indicate that a blueprint is to be implemented by the edge device. The blueprint token may be obtained by receiving it from another device, by reading it from storage, by generation based on user input, and/or via other methods.

At operation 302, a determination is made regarding whether the blueprint is trusted. The determination may be made by (i) attempting to verify that the blueprint token is trusted, and (ii) verifying that a signature for verification data for the blueprint can be verified. The attempt to verify that the blueprint token is trusted may be performed by using a trusted key to check a signature of the blueprint token and using content of the trusted token to determine whether a replay attack is being performed using the blueprint token. If the signature cannot be verified or a replay attack is being performed, then the blueprint token may be treated as not being trusted, but if the signature can be verified and a replay attack is not being performed, then the blueprint token may be treated as being trusted.

If the blueprint is trusted, then the method may proceed to operation 304. Otherwise, the method may proceed to operation 312.

At operation 304, a determination is made regarding whether the blueprint is authorized for use by the edge device. The determination may be made by (i) identifying assignment tickets for the edge device, (ii) checking signature of the assignment tickets to identify trustworthy assignment tickets (e.g., that have signatures that can be verified using trusted keys), and (iii) the blueprint may be compared to identifiers of blueprints specified by the trustworthy assignment tickets to see if the blueprint is listed in one of the trustworthy assignment tickets (e.g., that specify the blueprints usable with the edge device). If the blueprint is listed, then the blueprint may be treated as being authorized for use by the edge device.

If the blueprint is authorized for use by the edge device, then the method may proceed to operation 306. Otherwise the method may proceed to operation 312.

At operation 306, a determination may be made regarding whether integrity of the blueprint can be verified. The determination may be made by computing a hash of the blueprint, and comparing the hash to a hash in the integrity data for the blueprint. If the hashes match, then the integrity of the blueprint can be verified.

If the integrity of the blueprint can be verified, then the method may proceed to operation 308. Otherwise, the method may proceed to operation 312.

At operation 308, objects specified by the blueprint and that can be verified are implemented in an order specified by the blueprint. Doing so may conform operation of the edge device to the blueprint. The objects may be implemented in the order specified by the blueprint by ingesting the blueprint into automation software. The automation software may perform actions specified by the blueprint in the order specified by the blueprint. The actions may cause the objects to be implemented (e.g., by installing software, modifying configuration settings, etc.).

While implementing the objects, the objects may be verified (e.g., via hash matching). Objects that cannot be verified by be omitted from being implemented. For example, that actions that would implement the unverifiable objects may be skipped.

At operation 310, while the objects are being implemented, the implementation process may be logged to obtain an auditable implementation log. The implementation process may be logged by adding information regarding the process to a data structure. For example, the resulting auditable implementation log may specify activity performed based on corresponding portions of the blueprint, activity omitted from performance due to objects being unverifiable, and/or other types of information regarding the performed process and/or outcomes from the performance of the process.

The method may end following operation 310.

Thus, using the method shown in FIG. 3, embodiments disclosed herein may facilitate changes in computer implemented services provided by edge devices using blueprints. To reduce the likelihood of compromise of entities of the system due to the changes, various security actions may be performed in accordance with a security framework used to manage the process of changing operation of edge devices using the blueprints.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of endpoint devices of a deployment, the method comprising:
obtaining, by an endpoint device of the endpoint devices, a blueprint token that indicates that the endpoint device is to implement a blueprint;
in response to obtaining the blueprint token and by the endpoint device:
making a first determination regarding whether a blueprint specified by the blueprint token is trusted;
in a first instance of the first determination where the blueprint is trusted:
making a second determination regarding whether the blueprint is authorized for use by the endpoint device;
in a first instance of the second determination where the blueprint is authorized for use by the endpoint device:
making a third determination regarding whether integrity of the blueprint can be verified;
in a first instance of the third determination where the integrity of the blueprint can be verified: implementing a portion of objects specified by the blueprint that can be verified, the objects being implemented in an order specified by the blueprint, and implementation of the portion of the objects conforming the operation of the endpoint device to the blueprint; and providing computer implemented services using at least the portion of objects.

2. The method of claim 1, further comprising:
in the first instance of the third determination where the integrity of the blueprint can be verified:
while the objects are being implemented, logging activity of the endpoint device to obtain an auditable implementation trail for the endpoint device.

3. The method of claim 1, wherein making the first determination comprises:
obtaining verification data for the blueprint; and
attempting to verify trust in the blueprint using the verification data to make the first determination.

4. The method of claim 3, wherein the verification data comprises a hash of the blueprint that is signed, and attempting to verify the trust in the blueprint comprises using a public key to check a signature applied to the hash.

5. The method of claim 1, wherein making the second determination comprises:
obtaining at least one assignment for blueprints to the endpoint device; and
comparing the blueprint to the blueprints to ascertain whether the blueprint is one of the blueprints to make the second determination.

6. The method of claim 5, wherein each of the at least one assignment attests an assignment of at least one of the blueprints for use by the endpoint device, the at least one assignment being made by an administrator, and the at least one assignment being cryptographically verifiable by the endpoint device.

7. The method of claim 1, wherein making the third determination comprises:
obtaining verification data for the blueprint; and
comparing a first hash in the verification data to a second hash of the blueprint to make the third determination.

8. A non-transitory machine-readable medium having instructions stored therein, which when executed by a processor, cause the processor to perform operations for managing operation of endpoint devices of a deployment, the operations comprising:
obtaining, by an endpoint device of the endpoint devices, a blueprint token that indicates that the endpoint device is to implement a blueprint;
in response to obtaining the blueprint token and by the endpoint device:
making a first determination regarding whether a blueprint specified by the blueprint token is trusted;
in a first instance of the first determination where the blueprint is trusted:
making a second determination regarding whether the blueprint is authorized for use by the endpoint device;
in a first instance of the second determination where the blueprint is authorized for use by the endpoint device:
making a third determination regarding whether integrity of the blueprint can be verified;
in a first instance of the third determination where the integrity of the blueprint can be verified: implementing a portion of objects specified by the blueprint that can be verified, the objects being implemented in an order specified by the blueprint, and implementation of the portion of the objects conforming the operation of the endpoint device to the blueprint; and providing computer implemented services using at least the portion of objects.

9. The non-transitory machine-readable medium of claim 8, wherein the operations further comprise:
in the first instance of the third determination where the integrity of the blueprint can be verified:
while the objects are being implemented, logging activity of the endpoint device to obtain an auditable implementation trail for the endpoint device.

10. The non-transitory machine-readable medium of claim 8, wherein making the first determination comprises:
obtaining verification data for the blueprint; and
attempting to verify trust in the blueprint using the verification data to make the first determination.

11. The non-transitory machine-readable medium of claim 10, wherein the verification data comprises a hash of the blueprint that is signed, and attempting to verify the trust in the blueprint comprises using a public key to check a signature applied to the hash.

12. The non-transitory machine-readable medium of claim 8, wherein making the second determination comprises:
obtaining at least one assignment for blueprints to the endpoint device; and
comparing the blueprint to the blueprints to ascertain whether the blueprint is one of the blueprints to make the second determination.

13. The non-transitory machine-readable medium of claim 12, wherein each of the at least one assignment attests an assignment of at least one of the blueprints for use by the endpoint device, the at least one assignment being made by an administrator, and the at least one assignment being cryptographically verifiable by the endpoint device.

14. The non-transitory machine-readable medium of claim 8, wherein making the third determination comprises:
obtaining verification data for the blueprint; and
comparing a first hash in the verification data to a second hash of the blueprint to make the third determination.

15. An endpoint device, comprising:
a processor; and
a memory coupled to the processor to store instructions, which when executed by the processor, cause the processor to perform operations for managing operation of the endpoint device as a member of a deployment, the operations comprising:
obtaining a blueprint token that indicates that the endpoint device is to implement a blueprint;
in response to obtaining the blueprint token:
making a first determination regarding whether a blueprint specified by the blueprint token is trusted;
in a first instance of the first determination where the blueprint is trusted:
making a second determination regarding whether the blueprint is authorized for use by the endpoint device;
in a first instance of the second determination where the blueprint is authorized for use by the endpoint device:
making a third determination regarding whether integrity of the blueprint can be verified;
in a first instance of the third determination where the integrity of the blueprint can be verified: implementing a portion of objects specified by the blueprint that can be verified, the objects being implemented in an order specified by the blueprint, and implementation of the portion of the objects conforming the operation of the endpoint device to the blueprint; and providing computer implemented services using at least the portion of objects.

16. The endpoint device of claim 15, wherein the operations further comprise:
in the first instance of the third determination where the integrity of the blueprint can be verified:
while the objects are being implemented, logging activity of the endpoint device to obtain an auditable implementation trail for the endpoint device.

17. The endpoint device of claim 15, wherein making the first determination comprises:
obtaining verification data for the blueprint; and
attempting to verify trust in the blueprint using the verification data to make the first determination.

18. The endpoint device of claim 17 wherein the verification data comprises a hash of the blueprint that is signed, and attempting to verify the trust in the blueprint comprises using a public key to check a signature applied to the hash.

19. The endpoint device of claim 15, wherein making the second determination comprises:
obtaining at least one assignment for blueprints to the endpoint device; and
comparing the blueprint to the blueprints to ascertain whether the blueprint is one of the blueprints to make the second determination.

20. The endpoint device of claim 19, wherein each of the at least one assignment attests an assignment of at least one of the blueprints for use by the endpoint device, the at least one assignment being made by an administrator, and the at least one assignment being cryptographically verifiable by the endpoint device.
